(19) United States
(12) Patent Application Publication
(10) Pub. No.: US 2004/0015993 A1
(43) Pub. Date: Jan. 22, 2004

(54) System and method for providing movies on demand

(76) Inventors: Michael W. Yacenda, Stamford, CT (US); Michael W. Yacenda III, Stamford, CT (US)

Correspondence Address: F. Chau & Associates, LLP, Suite 501, 1900 Hempstead Turnpike, East Meadow, NY, 11554, US

(21) Appl. No.: 10/196,886

(22) Filed: Jul. 17, 2002

(51) Int. Cl. H04N 7/173

(52) U.S. Cl. 725/87; 725/92; 725/98

(57) ABSTRACT

A system and method for providing movies on demand is provided. A central system will transmit movies from its inventory to a local storage and replay device. Viewers, at any time, can request a movie from a local inventory now stored in the local storage and replay device. The device communicates the request to view the movie to the central system which validates the request against a central device database checking subscription and billing parameters. If approved, the central system authorizes the device to play the movie. The central system will maintain a device database for each device tracking, among other things, the local movie inventory stored on each such device. The local device communicates the movie title played, start time and end time back to the central system and the central device database is updated. The central system uses this data for control, billing and royalty payment purposes.

### BACKGROUND OF THE INVENTION

1. Field of the Invention

This invention relates to a system and a method for enabling movies on demand or the equivalent of a virtual video store. Consumers will download movies, or other content, from a central site and either rent or purchase them. The present invention provides a centrally controlled local storage and replay device connected to a central system using existing content distribution systems, the Internet or other networking means. Movies are first downloaded to the centrally controlled local storage device and the device allows playback or purchase when requested by the consumer, if approved by the central system.

2. Description of the Related Art

To view a movie on a television (TV) at a consumer's home, today, there are several options:

1. Free TV. View the movies playing on the “for free” TV channels. Today's broadcast system does not have local storage capacity for content (movies). Movies are transmitted from a central system and immediately played by a receiving TV. Consumers may have recording devices (VCR's, TiVo™, etc.), for their own convenience, to play the broadcasted movie at a later time. These devices are not controlled from a central location. Additionally, the movie selection is very limited and the movies are interrupted by commercials.

2. Movie Channels. A consumer may subscribe to a movie service that broadcasts predetermined movies during fixed time slots, for example HBO™, Disney™, Flix™, etc. These services generally offer one movie per time slot and the movies are predetermined by the network. The average service provides between 30-40 different movies per 30-day period. Variety during prime time is more limited with the selection narrowed to about 10-15 unique titles during the month.

3. Pay-Per-View Channels. A consumer may subscribe to a pay-per-view service. These services offer a similar limited variety to movie channels except you pay a rental fee each time viewed. No purchase option is available. Additionally, the starting times of the movies are predetermined by the service distributing them.

4. Video Stores. A consumer may go to a video store and either rent or purchase a movie. Video stores offer a significantly larger selection of titles depending upon the inventory held by the store. The average number of unique titles per store range from 250-1000. The most frequently viewed videos are in the 100-200 range. The consumer must physically go to the store to pick up the movie. At the time the consumer wants to rent a particular title, the store may be out of stock. The consumer must return the title by a fixed time to avoid late fees.

5. Mail Order Movies. The consumer may subscribe to a movie mail subscription where movies are delivered and returned by mail.

Ideally, a consumer should have immediate access to a large inventory of movies available for rent or purchase without having to leave their homes. They should be able to easily search the inventory of available titles and request them using their remote control. Furthermore, the quality of the movie should be the best available. Currently, the resolution for RF broadcast “for free” TV is 480 horizontal scan lines per frame. High definition TV (HDTV) is available in certain markets at resolutions ranging from 720 to 1080 horizontal scan lines per frame.

However, there are several hurdles preventing this:

1. Intellectual Property Rights. Movies or content are intellectual property and can only be sold or rented if the appropriate royalties are paid by the distributor/consumer. If a movie is electronically transmitted and stored locally, e.g., in a computer, sufficient controls must be established so that unauthorized viewing is prevented.

2. Large Files. Files containing high quality movies are large and require significant storage capacity. An average movie will contain about 5-9 gigabytes of data depending on the length of the movie and the quality of the recording.

3. Limited Bandwidth. There is insufficient bandwidth to transfer the amount of data needed in the time frames needed.

4. Limited Number of Channels. There is an insufficient number of channels connected to households. Wireless broadcast TV supplies about 12 channels, analog cable companies supply about 110 channels, and digital cable and direct satellite TV supply about 500 channels. If only 110, or even 500, channels are available connecting households and a central broadcast company, then that is the limit on the amount of content that can be viewed at any one time. This means the broadcast company can only show 500 different movies at any particular time. Not all people what to watch the same movie at the same time. Viewership varies depending on time of day and day of week.

### SUMMARY OF THE INVENTION

It is therefore an object of the present invention to provide a system and method for providing movies on demand which vastly improves bandwidth utilization over existing distribution systems.

It is another object of the present invention to provide a system and method for providing movies on demand which increases the number of movies available to a user and increases the users flexibility in viewing movies.

To achieve the above and other objects, a new and improved system and method for providing movies on demand is provided. The system and method of the present invention uses centrally controlled local storage and replay capability in its new delivery system for movies. A central system will transmit movies from its inventory to a local storage and replay device (“LSARD”) in a consumer's home. The system may use any of the various available distribution network options to transmit the movie, including the current RF broadcast networks, cable networks, satellite networks, PTSN (Public Telephone Switched Network), the Internet or other distribution medium. Viewers, at any time, can select a movie from a local inventory now stored in the LSARD. The LSARD communicates a request to view the movie to the central system which validates the request against a central device database checking subscription and billing parameters. If approved, the central system authorizes the LSARD to play the movie almost instantaneously from the local inventory avoiding lengthy download times. The central system will maintain a device database for each LSARD tracking, among other things, the local movie inventory stored on each such device. The local device (LSARD) communicates the movie title played, start time and end time back to the central system and the central device database is updated. The central system uses this data for control, billing and royalty payment purposes.

According to one aspect of the present invention, a system for providing content on demand is provided including a central system for storing and managing distribution of content, the central system including an inventory of content; a distribution network for distributing a subset of the inventory from the central system; and at least one local storage and replay device for receiving and storing the subset, wherein when a user requests to play an individual selection of the subset, the local storage and replay device requests approval from the central system. The central system further includes a device database for tracking user information and user activity of the at least one local storage and replay device.

According to another aspect of the present invention, an apparatus for providing content on demand includes a storage means for storing a plurality of individual content selections; a processor for controlling operation of the apparatus; and a replay interface for acquiring approval from a remote central system to play an individual selection upon request by a user, the replay interface being coupled to an output device allowing the individual content selection to be played upon approval. The apparatus further comprises a plurality of network interfaces for interfacing to the remote central system through a distribution network and a converter for converting the plurality of individual content selections to a format playable by the output device. The storage means of the apparatus may be a fixed storage medium or a drive utilizing a removable storage medium.

According to a further aspect of the present invention, a method for providing content on demand is provided. The method including the steps of acquiring an inventory of content at a central system; determining a subset of the inventory to be distributed; distributing the subset to a plurality of local storage and replay devices over a distribution network; storing the subset in each of the plurality of local storage and replay devices; and upon a user requesting to play an individual selection of the subset stored in the local storage and replay device, acquiring approval from the central system to play the selection. The method further includes the step of scheduling the distribution of the subset during periods of low user activity. The method further includes the steps of recording user activity during play of the selection; transmitting the recorded activity to the central station; and billing the user based on the recorded user activity.

### BRIEF DESCRIPTION OF THE DRAWINGS

The above and other objects, features, and advantages of the present invention will become more apparent in light of the following detailed description when taken in conjunction with the accompanying drawings in which:

FIG. 1 is a schematic diagram of a system for providing movies on demand utilizing centrally controlled local storage and replay devices (LSARDs) in accordance with the present invention;

FIGS. 2A-2C are flowcharts illustrating the methods of downloading content, replaying the content by a consumer, and central system billing and royalty payment processing;

FIG. 3 is a block diagram of a first embodiment of the local storage and replay device (LSARD) in accordance with the present invention; and

FIG. 4 is a block diagram of a second embodiment of the LSARD which utilizes a digital video disk (DVD) drive.

### DETAILED DESCRIPTION OF THE PREFERRED EMBODIMENTS

Preferred embodiments of the present invention will be described herein below with reference to the accompanying drawings. In the following description, well-known functions or constructions are not described in detail to avoid obscuring the invention in unnecessary detail.

A system and a method for enabling movies on demand, or the equivalent of a virtual video store, is provided. The present invention provides a centrally controlled local storage and replay device (LSARD) connected to a central system using existing content distribution systems, the Internet or other networking means. Movies are first downloaded to the centrally controlled local storage device and the device allows playback or purchase when requested by the consumer if approved by the central system.

By downloading and locally storing a quantity of movies on the LSARD, a user will have instant access to all of the movies stored. The central system may download movies from its master library to any or all of the LSARD devices connected. The downloading may occur during periods of low user activity, e.g., when the LSARD is off, while the user is viewing broadcasted content, or according to a specific time schedule. For example, in 30 days, using one cable channel, the central system can download 300-450 movies to each LASRD on the system. Additionally, the central system may employ several channels of an existing distribution system to download more movies in a relatively short period of time. Once downloaded, the user has “on demand” access to the locally stored content. Furthermore, once a LASAD has received a new download it will notify the consumer “You've Got Movies” similar to notifications in today's e-mail systems.

Once the storage capacity of the LSARD is reached, the consumer can delete old titles to make room for new ones. The central system can also manage local storage automatically. For example, the central system can automatically delete the oldest movies to free storage capacity for new titles being transmitted. Local consumers may maintain a “Favorites” section of titles they wish to retain for longer periods. Each time a change is made in the local inventory, the change is transmitted to the central system where a device database is updated. The LSARD can be designed to contain virtually unlimited storage capacity as well as removable storage disks. Higher local storage capacity permits more movie titles available on demand.

A virtual address of each LSARD is maintained in the device database of the central system. This allows the central system the flexibility to download selected movies to selected LSARDs at selected times. Such a feature would be particularly useful if a request for a specific movie came from a limited number of users. Then that movie could be downloaded to those LSARDs as scheduling permits.

Movies are stored in the LSARD in an encrypted format and may not be replayed unless approval is received from the central system. While the movie data is being stored locally, its replay is controlled centrally. The data stored locally has no value until approval is received from the central system. For this reason, the movie data can be stored locally as long as needed. It is stored in a format that can only be replayed by a LSARD and only if authorized by the central system. While the data bytes are physically stored locally, they are managed centrally as if the storage device was physically at the central system location. The local storage capability allows the transmission of large quantities of data to occur continuously (24 hours, 7 days a week) making full usage of the limited bandwidth and channel constraints inhibiting movies on demand today.

The consumer can request to replay any of the movies in its local inventory at any time. The consumer selects a movie from the local inventory list that can be displayed alphabetically by title, person, type of movie etc. The LSARD device communicates the selection to the central system. The central system checks the central device database to determine, based on the type of subscription program selected by the consumer, whether they are allowed to play the movie. For example, the subscription might include the viewing of a fixed number of movies per 30-day period. Once that limit is reached, additional movies can be viewed for an additional cost. If the request meets the subscription requirements, the central system will instruct the local device to play the movie. By having the movies stored locally, the movies can be played at anytime, virtually instantaneously. With enough storage the consumer could have every movie ever made at his fingertips, and hence, have movies on demand.

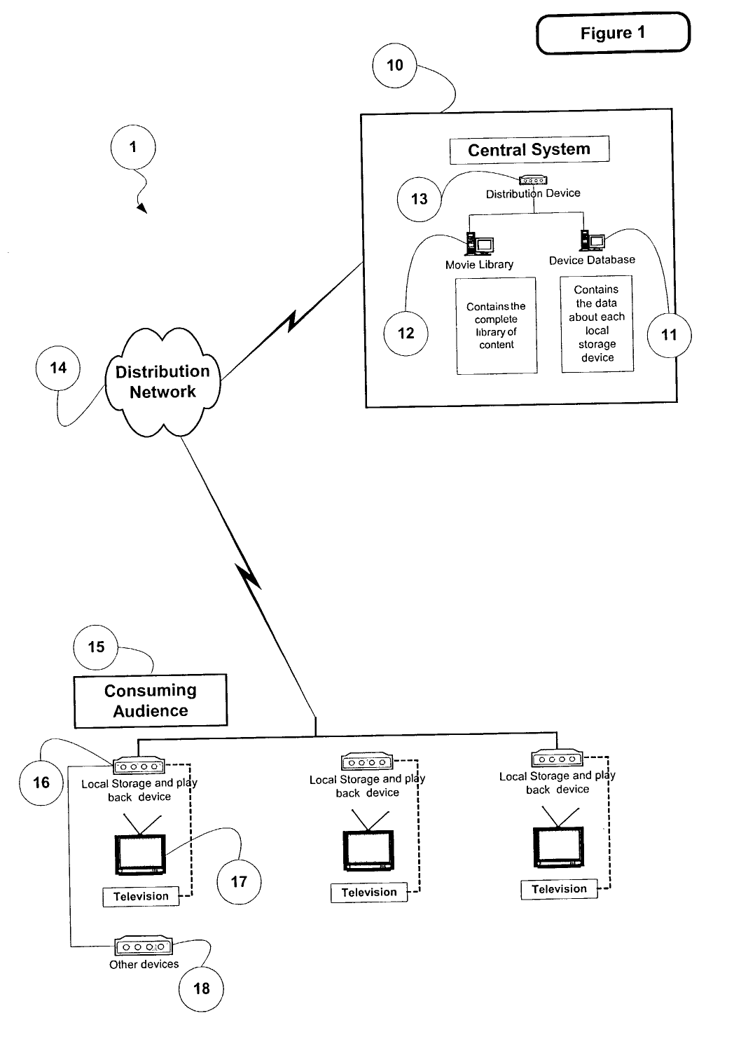

FIG. 1 is a schematic diagram of a system for providing movies on demand utilizing centrally controlled local storage and replay devices (LSARDs) in accordance with the present invention.

The system 1 includes a central system 10 for providing content (e.g. movies) and managing distribution of the content, a distribution network 14 for distributing the content and a plurality of local storage and replay devices (hereinafter, referred to as LSARDs) 16 for content playback. The plurality of LSARDs may be located in a home, commercial establishment, mobile home, boat or any location which has access to the distribution network 14. A collection of these LSARDs may also be referred to as a consuming audience 15.

Although the present invention will be described in conjunction with providing movies on demand, it is to be understood that the system and method of the present invention can provide any content including movies, videos, television programs, music, music videos, audio and electronic books, software, games, and the like.

The central system 10 includes a device database 11, a movie library 12 and a distribution device 13. The device database 11 tracks key data about each local storage and replay device 16 (LSARD). Examples of key data include device number, name and address of consumer, type of subscription plan, billing information, local movie inventory, download history (i.e. date, title and size of movies downloaded), viewing history (i.e. date, start time and end time of movie played), and deletion history. This database is updated for each movie downloaded, deleted, or viewed. The device database 11 is consulted by the central system 10 to approve requests from the LSARD 16.

The movie library 12 includes all of the movies allowed to be distributed by the central system 10. The actual physical storage of the movie data may be on several devices and media. Movies are continuously downloaded by the distribution device 13 according to a predetermined schedule. The schedule can be changed to meet special requests of the consuming audience 15. The distribution device 13 may encrypt or compress the movies before distribution. The distribution device 13 is connected to the LSARDs through the distribution network 14 which may be RF broadcast networks, cable networks, satellite transmission networks, the Internet, the PSTN or any other network capable of distributing digital or analog data.

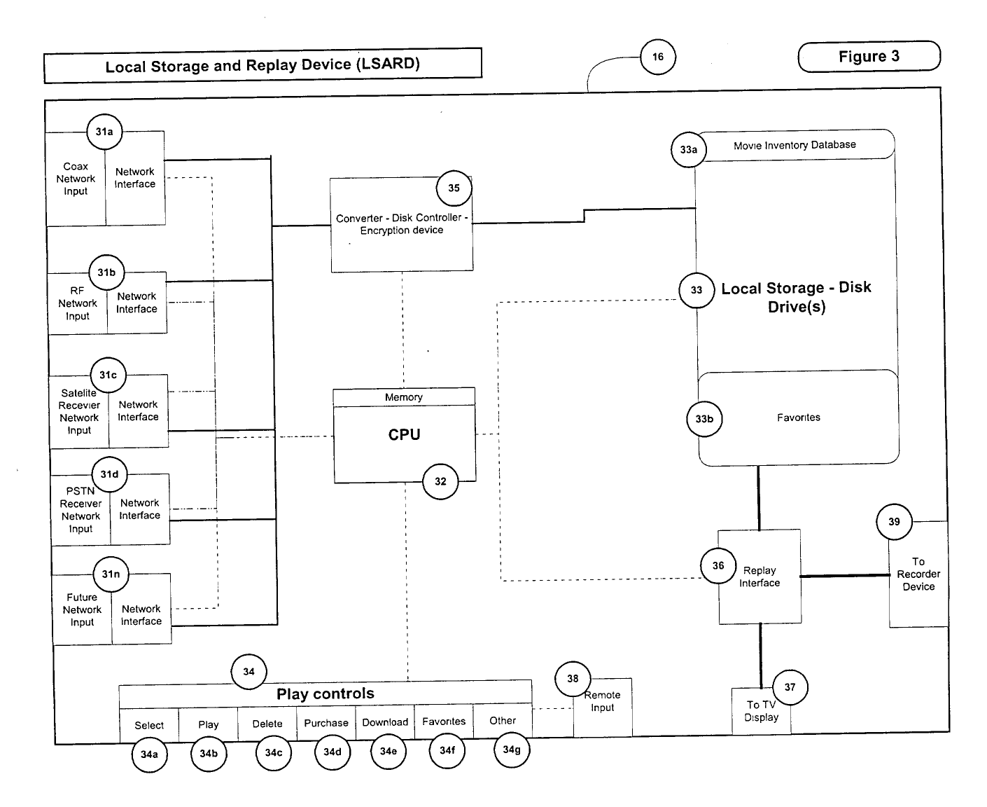

The local storage and replay device 16 (LSARD) generally includes a central processor, network interface, storage medium and playback controls. The LSARD 16 is coupled to the distribution network 14 and stores the movies received from the central system. The LASRD can pass the other channels or content to a television 17 for immediate viewing while receiving the downloading content. Transmission and storage is encrypted so the movie cannot be played back other than through the LSARD and only if authorized by the central system. In effect, the LSARD is an extension of the central system. An architecture of a typical LSARD will be described in detail below in conjunction with FIG. 3.

Other devices 18 will also be accessible to the LSARD. For example, should the consumer decide to purchase a movie, it may be stored in a long-term permanent sector of the local storage device 33 or transmitted to a recording device 39 such as a DVD burner or standard video cassette recorder (VCR). If the consumer requests to purchase the movie, the central system will authorize the purchase and instruct the local device 16 to communicate with the other device 18. In this way, movies can be distributed and sold to the local consumer as if they went into a video store. The LSARD 16 will update the central device 11 database for billing and royalty payment purposes. The central device database 11 will bill the consumer for all movies viewed or purchased as well as keep track of the royalty obligations to the owners of the movie, as will be described below.

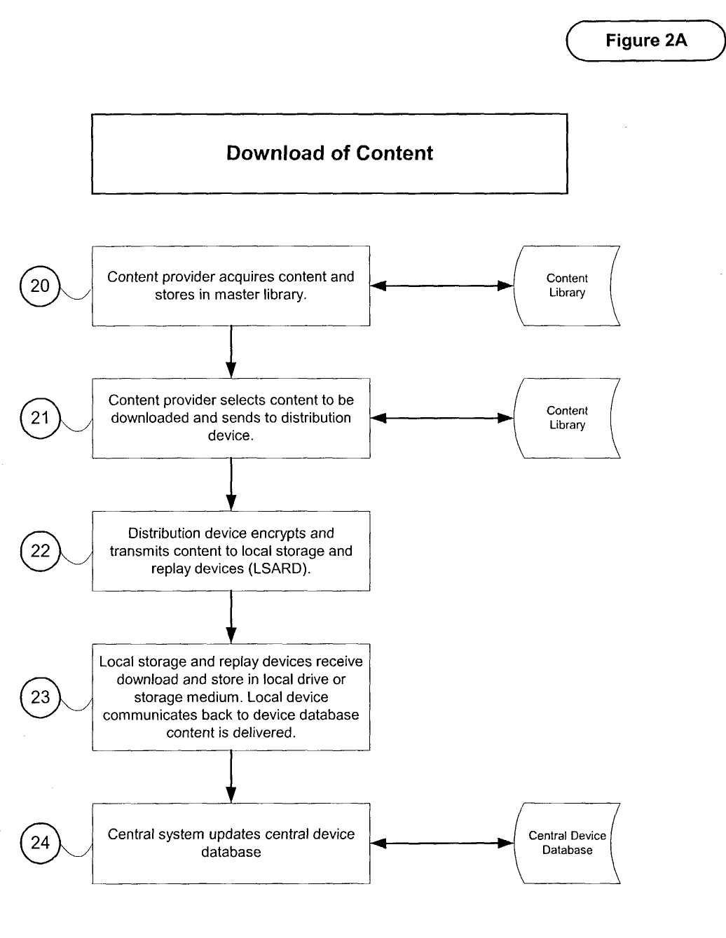

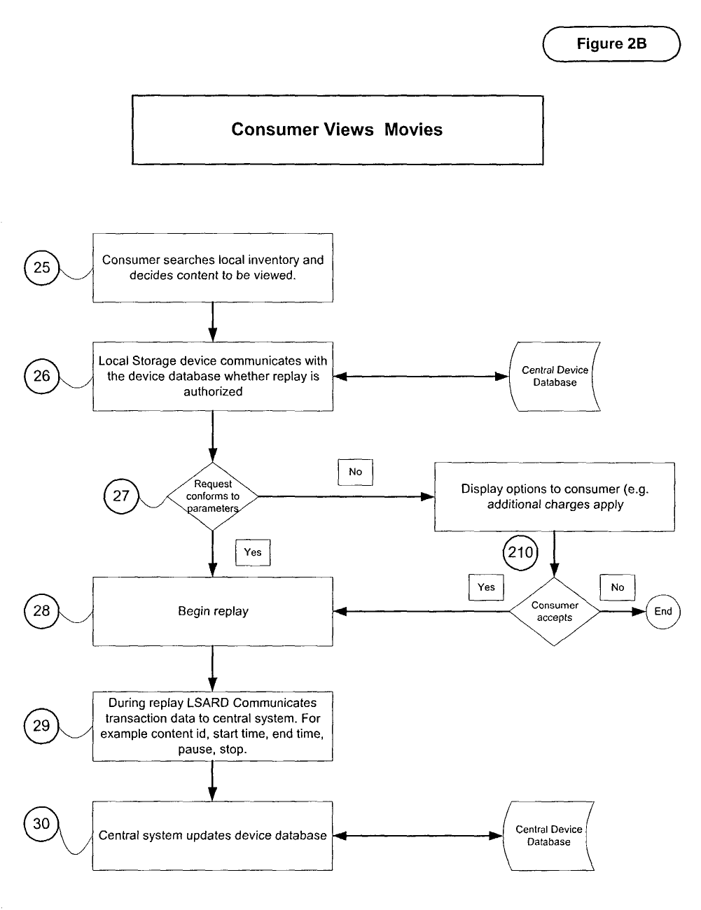

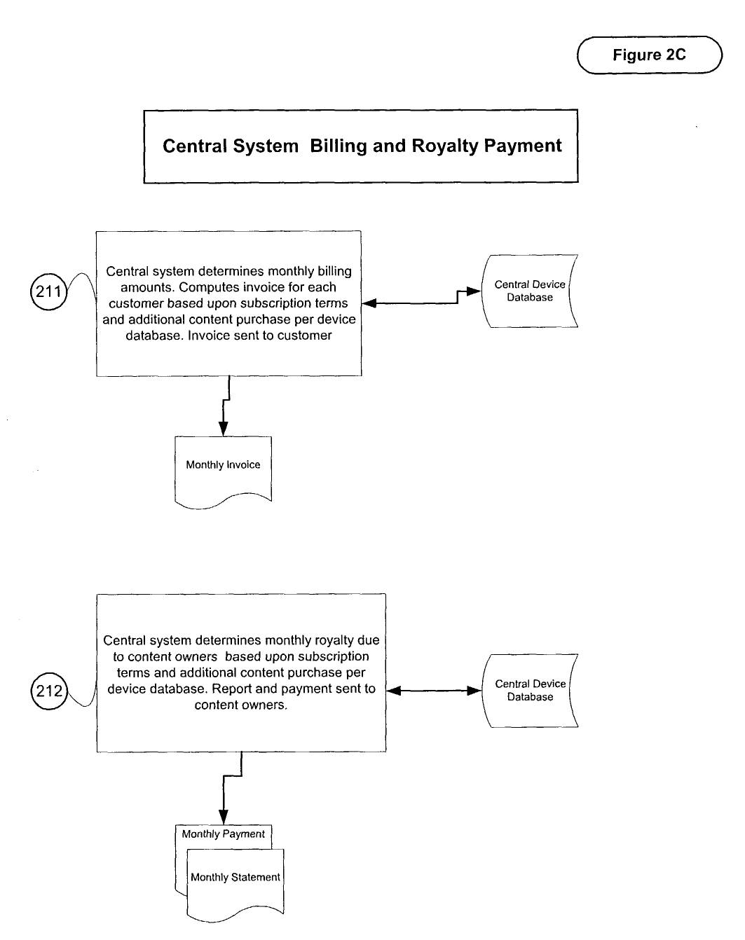

FIGS. 2A through 2C depicts process flowcharts for key functions of the system of FIG. 1: Download of content, Consumer playback, and central billing and royalty payments.

Referring to FIG. 2A, a content provider will store titles (e.g. movies) they are permitted to distribute in a central content library (step 20). The content provider will schedule an inventory of movies (step 21) to be downloaded base upon a variety of factors including general popularity of the movie, new releases, requests from the customer base etc. It is to be understood that the inventory to be downloaded is only a subset of the entire content library. The schedule is communicated to the distribution device 13, the inventory is retrieved from the library, optionally encrypted and/or compressed and transmitted to the LSARDs (step 22). The LSARD's receive the download and communicate back to the central system that it has successfully received and stored the movies (step 23). The central system updates the central device database 11 of the movie titles downloaded (step 24) and now stored as a local inventory in the LSARD.

Referring to FIG. 2B, when the consumer decides to view a movie, they will search the local inventory of the titles available (step 25). The search can be conducted a variety of ways including by title, person, production company, type of movies, time of release etc. Once the title is selected, the LSARD communicates the request to the central system (step 26). The central system recognizes the local device 16 and retrieves the device's record containing the subscription parameters and consumption to date. The central system validates that the request is valid and sends and instructions to the LSARD to play the movie (step 27). The LSARD begins playback and the consumer can view the movie on the TV or other output device (step 28). During the replay, the consumer may pause, rewind, fast forward and do all of the same functions as any other playback device such as a VCR or DVD player (step 29). Play parameters are transmitted to the central system including time of pauses, and stops (step 30). In this way, the central system has a complete record of the viewing transaction. The central system may only allow a single replay of the movie or may allow unlimited replays during a fixed period (e.g. 24 hours, week, month etc.) depending upon subscription parameters. If the request is not valid, the central system will communicate the options to the consumer (step 210), e.g., “additional charges apply to view this movie”, “your subscription has ended”, etc.

It is to be understood that since the central system 10 is tracking the viewing activity of the local inventory, virtually any type of subscription plan is possible. Some of the options are:

A single play of any movie.

Unlimited replays of a single movie for a fixed period.

X movies per month as part of a subscription—more than X then pay-per-view.

Charge more for current releases; less for older ones. If you view a title a year after release you only pay, say, 50% of the price it was new.

Referring to FIG. 2C, the central system 10 will use the central device database 11 to compute the monthly charges for each device based upon the subscription plan and the usage during the month (step 211). Additionally, the central system 10 will use the central device database 11 to compute the monthly royalty due based upon the licensing agreements the distributor has with the owners of the movie rights (step 212). The central system will prepare the appropriate usage statements and the payment amounts due.

FIG. 3 illustrates a block diagram for the LSARD (local storage and replay device) of the present invention, where the solid lines represent the flow of content data and the dashed lines represent the flow of control information. The LSARD 16 includes a plurality of network interfaces 31a-n, a processor or CPU 32, a local storage device 33, play controls 34, a converter/encryption device 35 and a replay interface 36 for coupling the LSARD to a television, content player or recording device.

The LSARD interfaces with the distribution network 14 of FIG. 1 through the plurality of network interfaces 31a-n, where each of the interfaces correspond to an available distribution network. Distributed content is received by the network interfaces 31a-n and directed by the CPU 32 to the converter 35 and forwarded to the local storage device 33. The data may be compressed to reduce storage requirement, converted to a different format (e.g., analog to digital), or decrypted/encrypted. The CPU 32 tracks where the movie was stored and updates a movie inventory database 33a in the local storage device 33, e.g. a hard disk.

The play controls 34 provide the interface to various functions that may be initiated on the device itself or remotely through a device communicating with through remote input 38. To play a movie, the consumer uses a select function 34a of the play controls 34 to choose a title from the local movie inventory database 33a. The select function allows the consumer to search the local movie inventory database 33a using a variety of parameters including by title, person (either actor, director, producer etc), production company (WB™, Disney™, etc), recent releases, age of movie, type of movie etc. Once a movie is selected, it can be played using a play function 34b. Before the movie can actually be played, the CPU 32 instructs the replay interface 36 to obtain approval from the central system 10. If approval is received, the CPU 32 instructs the local storage 33 to send the movie to the TV display interface 37, where the movie is subsequently displayed on a television. Otherwise, if not authorized, the CPU 32 will send to the TV display interface 37 the appropriate rejection reason and options to the consumer. For example, the consumer may have exceeded the viewing limit for the month and is offered an option to purchase the additional selection at a given price. The play function 34b also includes pause, FF, reverse and other enhanced viewing features. When the consumer is finished viewing the movie, the end time is communicated to the central system where it is stored in the central device database 11. The consumer can select a movie for deletion by using a delete function 34c to make room for additional selections. The central system 10 approves the deletion request and updates the central device database.

The consumer may purchase a movie stored in the LSARD 16 by using a purchase function 34d. The CPU 32 instructs the replay interface 36 to obtain approval from the central system. The central system will communicate the current purchase price of the movie selected and request the consumer to accept the charge. If accepted, the replay interface 36 will allow the movie to be sent to the recorder interface 39 which may be coupled to a VCR, DVD Burner, DVR or other such recording device.

Furthermore, the download function 34e allows the consumer to view the movie library 12 of the central system of FIG. 1. The central system will review its broadcast schedule including the requests for the same movie title and communicate to the consumer the download timing. If the viewer accepts the timing (perhaps for an additional charge), the distribution device 13 of FIG. 1 will schedule the download.

Using a favorite function 34f, the consumer can earmark selected titles to be retained in the local storage device 33 as a Favorite 33b. The CPU 32 communicates the request to the central system and if approved updates the device database 11 of FIG. 1 and the local storage device 33 earmarks the title as a Favorite 33b. The number of movies to be stored will depend upon the subscription option and the size of the local storage capacity. Other 34g is reserved for future functions.

It is to be understood that the present invention may be implemented in various forms of hardware, software, firmware, special purpose processors, or a combination thereof. In one embodiment, the LSARD may be implemented as a set-top box coupled to a television and/or recording devices. Additionally, the LSARD can be embodied in a stand-alone television where all components reside in the television.

In a further embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and micro instruction code. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

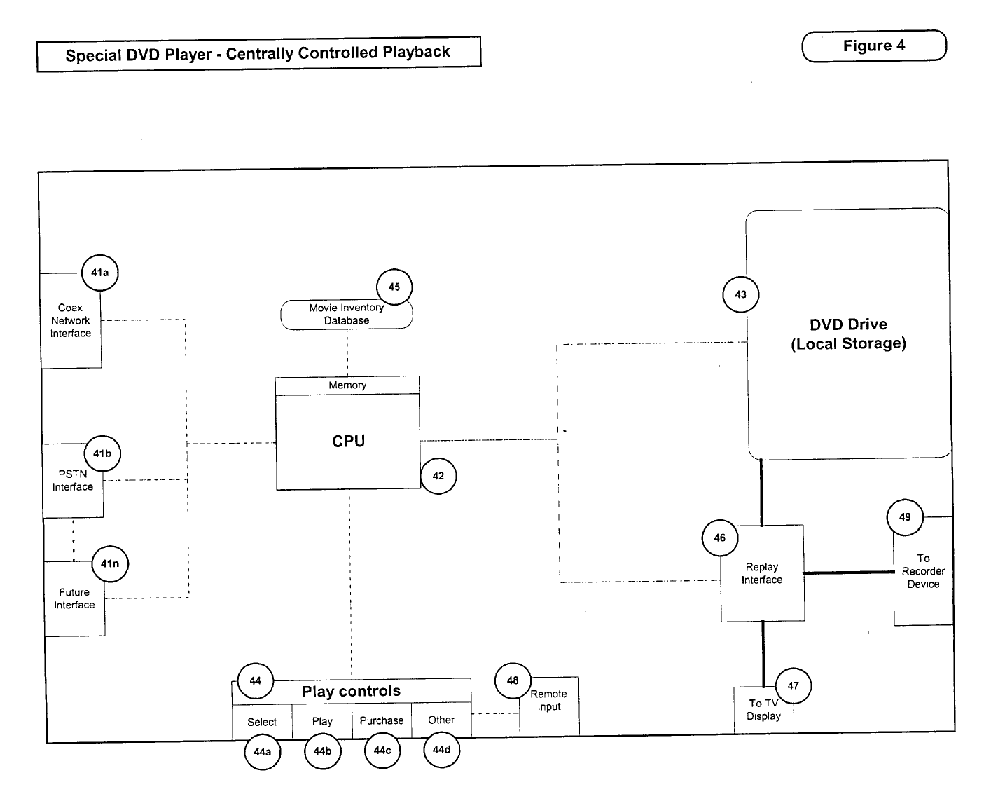

FIG. 4 is a block diagram of another embodiment of the LSARD which utilizes a digital video disk (DVD) drive. In this embodiment, the movie content is stored on a special DVD that can only be replayed in special LSARD equipped with a DVD drive. Rather than download the movies over the variety of networks, the content is mail or otherwise delivered to the consumer.

When the consumer decides to play a title, they insert a corresponding DVD into DVD Drive 43. The consumer requests to play 44b the title but before the movie can be played, the CPU 42 instructs the replay interface 46 to obtain approval from the central system. If approval is received, the CPU 42 instructs the DVD drive 43 to send the movie to the TV display interface and subsequently to a television 47. The play function 44b also includes pause, FF, reverse and other enhanced viewing features. When the consumer is finished viewing the movie, the end time is communicated to the central system where it updates the device database 11 of FIG. 1.

The consumer may purchase the movie by using a purchase function 44c. The CPU 42 instructs the replay interface 46 to obtain approval from the central system. The central system will communicate the current purchase price of the movie selected and request the consumer to accept the charge. If accepted, the replay interface 46 will allow the movie to be sent to the recorder interface 49 which could be a VCR, DVD Burner, DVR or other such recording device. When the recorder is finished recording the movie, the end time is communicated to the central system where it updates the device database 11. The device will track local titles in the movie inventory database 45 which can be searched using the select functions 44a.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A system for providing content on demand comprising:
a central system for storing and managing distribution of content, the central system including an inventory of content;
a distribution network for distributing a subset of the inventory from the central system; and
at least one local storage and replay device for receiving and storing the subset, wherein when a user requests to play an individual selection of the subset, the local storage and replay device requests approval from the central system.

2. The system as in claim 1, wherein the central system further comprises a device database for tracking user information and user activity of the at least one local storage and replay device.

3. The system as in claim 1, wherein the central system further comprises a distribution device for scheduling the distribution of content.

4. The system as in claim 1, wherein the local storage and replay device comprises
a processor for controlling operation of the local storage and replay device;
a storage means for storing the subset of inventory received from the central system; and
a replay interface for acquiring approval from the central system to play the selection.

5. The system as in claim 4, wherein the local storage and replay device further comprises a plurality of network interfaces for interfacing to the distribution network.

6. The system as in claim 4, wherein the local storage and replay device further comprises a converter for converting the received subset of inventory to a format playable by the local storage and replay device.

7. The system as in claim 4, wherein the local storage and replay device further comprises play controls for issuing user commands to the local storage and replay device.

8. The system as in claim 4, wherein the storage means is a fixed storage medium.

9. The system as in claim 4, wherein the storage means is a removable storage medium.

10. An apparatus for providing content on demand comprising:
a storage means for storing a plurality of individual content selections;
a processor for controlling operation of the apparatus; and
a replay interface for acquiring approval from a remote central system to play an individual selection upon request by a user, the replay interface being coupled to an output device allowing the individual content selection to be played upon approval.

11. The apparatus as in claim 10, further comprising a plurality of network interfaces for interfacing to the remote central system through a distribution network.

12. The apparatus as in claim 10, further comprises a converter for converting the plurality of individual content selections to a format playable by the output device.

13. The apparatus as in claim 10, further comprises play controls for issuing user commands to the apparatus.

14. The apparatus as in claim 10, wherein the storage means is a fixed storage medium.

15. The apparatus as in claim 10, wherein the storage means is a removable storage medium.

16. A method for providing content on demand, the method comprising the steps of:
acquiring an inventory of content at a central system;
determining a subset of the inventory to be distributed;
distributing the subset to a plurality of local storage and replay devices over a distribution network;
storing the subset in each of the plurality of local storage and replay devices; and
upon a user requesting to play an individual selection of the subset stored in the local storage and replay device, acquiring approval from the central system to play the selection.

17. The method as in claim 16, further comprising the step of scheduling the distribution of the subset during periods of low user activity.

18. The method as in claim 16, further comprising the step of encrypting the subset before distribution.

19. The method as in claim 16, further comprising the step of compressing the subset before distribution.

20. The method as in claim 16, wherein during the acquiring approval step, if the central system denies the request, presenting to the user options to obtain approval.

21. The method as in claim 16, further comprising the steps of:
recording user activity during play of the selection; and
transmitting the recorded activity to the central station.

22. The method as in claim 21, further comprising the step of billing the user based on the recorded user activity.

23. The method as in claim 16, further comprising the step of notifying the user of changes to the subset stored in the local storage and replay device.

24. A program storage device readable by machine, tangibly embodying a program of instructions executable by the machine to perform method steps for providing content on demand, the method steps comprising:
acquiring an inventory of content at a central system;
determining a subset of the inventory to be distributed;
distributing the subset to a plurality of local storage and replay devices over a distribution network;
storing the subset in each of the plurality of local storage and replay devices; and
upon a user requesting to play an individual selection of the subset stored in the local storage and replay device, acquiring approval from the central system to play the selection.

25. The program storage device as in claim 24, further comprising the step of scheduling the distribution of the subset during periods of low user activity.

26. The method as in claim 24, further comprising the step of encrypting the subset before distribution.

27. The method as in claim 24, further comprising the step of compressing the subset before distribution.

28. The method as in claim 24, wherein during the acquiring approval step, if the central system denies the request, presenting to the user options to obtain approval.

29. The method as in claim 24, further comprising the steps of:
recording user activity during play of the selection; and
transmitting the recorded activity to the central station.

30. The method as in claim 29, further comprising the step of billing the user based on the recorded user activity.
